(19) United States
(12) Patent Application Publication
(10) Pub. No.: US 2007/0021531 A1
(43) Pub. Date: Jan. 25, 2007

(54) Combination of polymer slurry types for optimum pipeline drag reduction

(75) Inventors: John F. Motier, Broken Arrow, OK (US); Jeffrey R. Harris, Tulsa, OK (US); Lu Chien Chou, Tulsa, OK (US); Nagesh S. Kommareddi, Broken Arrow, OK (US)

Correspondence Address: PAUL S MADAN;MADAN, MOSSMAN & SRIRAM, PC, 2603 AUGUSTA, SUITE 700, HOUSTON, TX, 77057-1130, US

(73) Assignee: Baker Hughes Incorporated, Houston, TX (US)

(21) Appl. No.: 11/451,768

(22) Filed: Jun. 13, 2006

Related U.S. Application Data
(60) Provisional application No. 60/690,345, filed on Jun. 14, 2005.

(51) Int. Cl. C09K 3/00

(52) U.S. Cl. 523/175

(57) ABSTRACT

A method of extending or broadening the effective time of drag reduction for a drag reducing agent in a pipeline may be custom-designed by combining two drag reducing slurries or other drag reducing products made by different or alternative techniques. For instance a precipitation polymer slurry derived from polymer precipitation where the polymer dissolves relatively quickly can be combined with a ground polymer slurry derived by grinding bulk polymer (ground at either cryogenic or non-cryogenic temperatures), or by using other size reduction techniques, where the latter polymer dissolves relatively slowly. In one non-limiting embodiment of the invention, bulk polymer may be ground directly into a precipitation polymer slurry to make the ground polymer slurry and blend the slurries simultaneously, where the precipitation polymer slurry serves as an anti-agglomeration agent.

### CROSS-REFERENCE TO RELATED APPLICATION

This application claims the benefit of U.S. Provisional Application No. 60/690,345 filed Jun. 14, 2005.

### TECHNICAL FIELD

The invention relates to processes for producing polymeric drag reducing agents useful to reduce friction in flowing hydrocarbons, and most particularly to processes for producing polymeric drag reducing agents that are effective over a relatively extended period of time.

### BACKGROUND

The use of polyalpha-olefins or copolymers thereof to reduce the drag of a hydrocarbon flowing through a conduit, and hence the energy requirements for such fluid hydrocarbon transportation, is well known. These drag reducing agents or DRAs have taken various forms in the past, including slurries or dispersions of ground polymers to form free-flowing and pumpable mixtures in liquid media. A problem generally experienced with simply grinding the polyalpha-olefins (PAOs) is that the particles will “cold flow” or stick together after the passage of time, thus making it impossible to place the PAO in the hydrocarbon liquid where drag is to be reduced, in a form of suitable surface area, thus particle size, that will dissolve or otherwise mix with the hydrocarbon in an efficient manner. Further, conventional grinding process employed in size reduction may degrade the polymer, thereby reducing the drag reduction efficiency of the polymer.

One common solution to preventing cold flow during the grinding process is to coat the ground polymer particles with an anti-agglomerating agent. Cryogenic grinding of the polymers to produce the particles prior to or simultaneously with coating with an anti-agglomerating agent has also been used. Some powdered or particulate DRA slurries require special equipment for preparation, storage and injection into a conduit to ensure that the DRA is completely dissolved in the hydrocarbon stream. The formulation science that provides a dispersion of suitable stability so that it will remain in a pumpable form necessitates this special equipment.

Gel or solution DRAs (those polymers essentially being in a viscous solution with hydrocarbon solvent) have also been tried in the past. However, these drag reducing gels also demand specialized injection equipment, as well as pressurized delivery systems. The gels or the solution DRAs are stable and have a defined set of conditions that have to be met by mechanical equipment to pump them, including, but not necessarily limited to viscosity, vapor pressure, undesirable degradation due to shear, etc. The gel or solution DRAs are also limited to about 10% activity of polymer as a maximum concentration in a carrier fluid due to the high solution viscosity of these DRAs. Thus, transportation costs of some DRA products are considerable, since up to about 90% of the volume being transported and handled is inert material.

U.S. Pat. No. 2,879,173 describes a process for preparing free-flowing pellets of polychloroprene involving suspending drops of an aqueous dispersion of the polychloroprene in a volatile, water-immiscible organic liquid in which the polymer is insoluble at temperatures below −20° C. until the drops are completely frozen and the polychloroprene coagulated, separating the frozen pellets from the suspending liquid, coating them while still frozen with from 5% to 20% of their dry weight of a powder which does not react with the polychloroprene under normal atmospheric conditions, and removing the water and any adhering organic liquid through vaporization by warming the pellets.

A method for coating pellets of a normally sticky thermoplastic binder material by using a mixture of a minor proportion of a vinyl chloride/vinyl acetate copolymer and a major proportion of a chlorinated paraffin wax with powdered limestone or talc powder is described in U.S. Pat. No. 3,351,601.

U.S. Pat. No. 3,528,841 describes the use of microfine polyolefin powders as parting agents to reduce the tackiness of polymer pellets, particularly vinyl acetate polymers and vinyl acetate copolymers.

Similarly, Canadian patent 675,522 involves a process of comminuting elastomeric material for the production of small particles that includes presenting a large piece of elastomeric material to a comminuting device, feeding powdered resinous polyolefin into the device, comminuting the elastomeric material in the presence of the powdered polyolefin and recovering substantially free-flowing comminuted elastomeric material.

A process for reducing oxidative degradation and cold flow of polymer crumb by immersing the crumb in a non-solvent such as water and/or dusting the crumb with a powder such as calcium carbonate and 2,6-di-t-butylparacresol, 4,4′-methylene-bis-(2,6-di-t-butylphenol) or other antioxidants is discussed in U.S. Pat. No. 3,884,252. The patent also mentions a process for reducing fluid flow friction loss in pipeline transmission of a hydrocarbon fluid by providing a continuous source of the dissolved polymer.

U.S. Pat. No. 4,016,894 discloses that drag in turbulent aqueous streams is reduced by a powder composition of a finely divided hygroscopic drag reducing powder, for example poly(ethylene oxide), and a colloidal size hydrophobic powder, for example, an organo silicon modified colloidal silica, and an inert filler such as sodium sulfate. The powder composition is injected into the turbulent stream.

It would be desirable if a drag reducing agent could be developed which rapidly dissolves in the flowing hydrocarbon (or other fluid), which could minimize or eliminate the need for special equipment for preparation and incorporation into the hydrocarbon. It would also be desirable to have a process for producing particulate drag reducing agent that did not require cryogenic grinding in its preparation and/or only grinding or other size reduction under ambient temperature conditions. In particular, it would be advantageous to have a drag reducing composition that would be effective over a relatively extended period of time, instead of losing its effectiveness after a shorter period.

### SUMMARY

There is provided, in one non-limiting form, a drag reducing composition for reducing drag in a hydrocarbon fluid in a controlled manner over a period of time having a precipitation polymer slurry formed by polymer precipitation, where the polymers of the precipitation polymer slurry dissolves relatively quickly in the hydrocarbon fluid, together with a size-reduced polymer formed by grinding or otherwise reducing the size of bulk polymer. The method for size reduction is either cryogenic size reduction and/or size reduction in the absence of cryogenic temperatures, where the size-reduced polymer dissolves relatively slowly in the hydrocarbon fluid. The size-reduced polymer may optionally be directly combined with the precipitation polymer slurry upon size reduction or optionally combined with a liquid media to form a size-reduced polymer slurry which is in turn combined with the precipitation polymer slurry.

In another non-limiting embodiment of the invention there is provided a method for making a drag reducing composition for reducing drag in a hydrocarbon fluid in a controlled manner over a period of time. The method involves forming a precipitation polymer slurry by precipitating a polymer, where the precipitation polymer slurry dissolves relatively quickly in a hydrocarbon fluid. The method additionally involves forming a size-reduced polymer by grinding or other size reduction process, where the size reduction is conducted by cryogenic size reduction and/or size reduction in the absence of cryogenic temperature, or in another non-limiting embodiment at ambient temperature, where the size-reduced polymer slurry dissolves relatively slowly in a hydrocarbon fluid. The size-reduced polymer may be introduced after its size reduction (e.g. grinding) into a liquid media to form a size-reduced polymer slurry which in turn is combined. In another non-limiting embodiment, forming the size-reduced polymer slurry may involve grinding the bulk polymer into the precipitation polymer slurry.

In yet another non-limiting embodiment of the invention, the invention concerns methods of using the drag reducing compositions mentioned above in reducing the drag of hydrocarbon fluids flowing through a pipeline, conduit and elsewhere, and hydrocarbon streams so treated.

### BRIEF DESCRIPTION OF THE DRAWINGS

FIG. 1 is a chart plotting the dissolution as a function of time of polymers in kerosene where the polymers are made by two different processes; and

FIG. 2 is a is a chart plotting the % drag reduction as a function of time of two polymers in kerosene where the polymers are made by two different processes and a third mixture of the two polymers.

### DETAILED DESCRIPTION

The drag reducing polymers in drag reducing polymer slurries derived from precipitation dissolve relatively rapidly in hydrocarbon streams to effect drag reduction that becomes susceptible to shear degradation. The drag reducing polymers in drag reducing polymer slurries derived from ambient or cryogenically size-reduced bulk polymers may have relatively delayed dissolution, delayed effect on drag, and delayed susceptibility to degradation. Within the context of the methods and compositions herein, the term “bulk polymer” refers to polymer made by bulk polymerization where little or no solvent is present.

It has been discovered that combining, mixing or blending the two types provides a mechanism to tailor a DRA system to meet the requirements of any given pipeline. Pipelines of different lengths, throughput, and hydrocarbon content, to name a few of the interrelated factors, require tailored or customized drag reducing treatments for optimum performance. The use of multiple mechanisms in a drag reducing composition extends broadens, expands, enlarges, and otherwise lengthens the time period that drag reduction is effective. It is also possible to use a precipitation-type slurry as the “quenching” agent or system receive, accept, contain and incorporate ground polymer to avoid agglomeration.

It will be appreciated that by stating that the precipitation polymer slurry dissolves relatively quickly in a hydrocarbon fluid, that it is meant that the polymer of such slurry dissolves more rapidly than do the polymers of the size-reduced polymer slurry used in the drag reducing composition. Similarly, by stating that ground polymer slurry dissolves relatively slowly in a hydrocarbon fluid, it is meant that the polymer of such slurry dissolves more gradually than do the polymers of the precipitation polymer slurry used in the drag reducing composition. It will be appreciated that it is not possible to predict in advance what the difference in the rate of dissolution of the polymers of the two slurries should be, since this will depend upon a number of complex, interrelated factors including, but not necessarily limited to, the compositions of the slurries, the ratios of the slurries used, the nature (compositions) of the hydrocarbon stream being treated, the conditions of the hydrocarbon stream being treated (e.g. temperature, pressure flow rate, etc.), the desired degree of drag reduction, and the like. Nevertheless, in one non-limiting embodiment the ratio of the precipitation polymer to the size-reduced polymer may range from about 4:1 to about 1:4, and alternatively have a lower proportion ratio of about 1.5:1 and independently an upper proportion ratio of about 1:1.5.

It will be appreciated that in one non-limiting embodiment of the invention that more than one precipitation polymer slurry could be used and/or more than one size-reduced polymer slurry could be used to tailor or customize the drag reduction composition further to a particular hydrocarbon stream and/or pipeline.

In one non-limiting embodiment of the invention, the polymer in the precipitation polymer slurry and the polymer in ground polymer slurry are the same. Alternatively, the polymers in the two slurries may be different. In another non-limiting embodiment of the invention, the polymer in the precipitation polymer slurry and the polymer in ground polymer slurry are the same or different poly(alpha-olefin). Poly-alphaolefins particularly suitable for the processes and compositions of this invention include the FLO® family of PAO DRAs, including FLO® XL Pipeline Booster DRAs sold by Baker Pipeline Products, a division of Baker Performance Chemicals, Inc.

Preparation of the Precipitation Polymer Slurry

The precipitation polymer slurries suitable in the subject invention include, but are not necessarily limited to the low viscosity, high concentration drag reducing agent (DRA) slurries produced in accordance with U.S. Pat. No. 5,733,953 to Fairchild, et al. (Baker Hughes Incorporated), incorporated herein by reference in its entirety.

In more detail, a high concentration drag reducing agent may be precipitated to form a useful slurry directly by carefully replacing the solvent in which the polymer is soluble with a liquid, nonsolvent for the polymer. The DRA slurry concentrate produced is readily soluble in a flowing hydrocarbon stream, and does not require the use of special equipment to inject it or otherwise deliver it into the stream.

In one non-limiting embodiment, a high molecular weight polyalphaolefin (PAO) is polymerized from the monomer or monomers in a solvent for the alpha-olefin monomers. A suitable non-solvent for the PAO is slowly added to the neat drag reducer, which may be simply the PAO in the solvent in which the polymerization occurs. The non-solvent should be added at a rate that will allow the drag reducer mixture to absorb the non-solvent. This rate depends on the amount of agitation in the mixing system used. If the rate of non-solvent addition is too high, it will make a precipitate that is not uniform in size with particles too large in size for use as a DRA in slurry form, and will contain undesirably high amounts of solvent. During the addition, the neat drag reducer will go through a viscosity reduction until the PAO precipitates. At this point, the mixture becomes a slurry concentrate of precipitated polymer particles overlaid by a supernatant layer of solvent and liquid, non-solvent. The weight ratio of liquid, non-solvent to solvent may range from about 70/30 to 30/70, where, in one non-limiting, preferred embodiment, the ratio is about 50/50.

The slurry concentrate at this point may cold flow if not agitated. To reduce or prevent the cold flow, it will be necessary to remove at least 50% of the solvent/liquid, non-solvent mixture and replace it with additional non-solvent. This lowers the amount of solvent in the precipitated polymer. The mixture of solvent and liquid, non-solvent would again be separated or removed to concentrate the polymer proportion to at least 15 wt. %. Typically, the polymer will again settle if not agitated, but can be slurried again with further agitation. In one embodiment of the invention, the storage tanks for the DRA on site will have to be equipped with circulation pumps to keep the slurry mixed. In another alternate embodiment, an optional anti-agglomeration agent may be added at this point. In a different alternate embodiment, additional solvent may be removed from the slurry concentrate by evaporating, such as through vacuum drying or other technique.

It will be appreciated that the above-described preparation is analogous to a two-step extraction. However, since precipitation is also occurring in the first step, the rate of addition of the liquid, non-solvent should be carefully controlled. In one embodiment, the liquid, non-solvent is added to a point where the polymer precipitates into polymer particles of average diameter equal or less than 0.10″ (0.25 cm). It is an advantage of this invention that the particle sizes average this small.

In still more detail, as noted, a liquid, non-solvent is slowly added to the polymer in a solvent at a rate to permit the polymer mixture to absorb the liquid, non-solvent. The rate that will vary with a variety of factors, including but not necessarily limited to, the mixing equipment available, and to some extent with the specific polymer, solvent, and liquid non-solvent employed. The addition of non-solvent proceeds until the polymer precipitates into polymer particles of average diameter of 0.10″ (0.25 cm) or less and the viscosity of the mixture decreases, in one non-restrictive embodiment. Again, this point will vary from system to system.

While the process conditions for the non-solvent addition and polymer precipitation may be ambient temperature and pressure, other conditions outside of ambient are anticipated as being useful. Of course, temperatures and pressures above and below ambient would affect the point at which precipitation took place, as well as the solubility characteristics of the various systems.

Suitable liquid, non-solvents for PAOs include, but are not necessarily limited to isopropyl alcohol (IPA), other alcohols, glycols, glycol ethers, ketones, esters, all of which contain from 2 to 6 carbon atoms. The weight ratio of non-solvent to solvent after the addition of the non-solvent may range from about 70/30 to about 30/70, preferably from about 60/40 to about 40/60, and in one non-limiting embodiment is especially preferred to be about 50/50. In other words, in one non-restrictive embodiment, at least 40 wt. % of the solvent is replaced with the liquid, non-solvent.

After precipitation of the polymer is complete, the slurry concentrate of precipitated polymer particles may be separated from the supernatant layer of solvent and liquid, non-solvent. This may be conducted by any available, conventional technique, such as decanting, cyclone separation, filtration, centrifugation or otherwise separating the supernatant layer, etc.

It is expected that to produce useful product that is easily handled, the residual solvent in the slurry concentrate of precipitated polymer particles must be further removed or reduced, preferably as much as possible. This may be done with an additional extraction-like step by adding additional non-solvent, and then further removing the formed liquid mixture. Solvent may also be evaporated to leave a slurry further concentrated containing polymer particles in predominantly liquid, non-solvent. By predominantly liquid, non-solvent is meant that the slurry concentrate contains less than 10 wt % solvent based on the total slurry concentrate.

Preparation of the Size-Reduced Polymer Slurry

With respect to the size-reduced polymer slurries described herein, it will be appreciated that the terms “size-reduced” and “size reduction” contemplate a number of different or alternative processes for reducing the size of discrete bulk polymer pieces, whatever their size. Suitable size-reduction techniques include, but are not necessarily limited to, grinding, homogenizing, milling, shear processes (e.g. high shear material processors such as MICROFLUIDIZER® high shear processors of MFIC Corporation), and the like. Further descriptions of the methods and compositions herein may involve only one or another of these size reduction techniques, but it will be appreciated that unless otherwise noted, other different size reduction may or might be used instead, including combinations of these.

A process has been discovered by which attrition mill pulverizing technology, in one non-limiting embodiment, can be utilized in combination with a blend of unique grinding aids to render a granulated polyolefin polymer into a ground state of fine particles of 600 microns or less at non-cryogenic conditions. The process in one non-restrictive embodiment involves the injection of atomized liquid grinding aid (composed of wetting properties such that lubricity is imparted to the grinding system) in unison with the introduction of organic solid grinding aid into the grinding chamber such that particle agglomeration and gel ball formation of soft polyolefins is minimized or prevented. The solid grinding aid may also be helpful to provide the shearing action necessary in the grinding or pulverizing chamber to achieve the small polymer particles of about 600 microns or less. Use of a single grinding aid such as the wetting agent, may produce particle sizes on the order of 1200 microns or greater. In the case of solid grinding aid used alone in the process, large gel ball formation may occur that prevents the grinding to a small particle size.

It has been found in some non-limiting embodiments that the solid grinding aid may be utilized as the primary and only grinding aid in the process. However, that process is restricted in achieving the smaller particle size distributions and is also limited in the speed by which the process may be run. One may grind faster and smaller by a combination of the two grinding aid types in other non-limiting embodiments. Nevertheless, in some non-restrictive embodiments, where the DRA polymer is relatively harder, it may not be necessary to use a liquid grinding aid. Where the DRA polymer is relatively softer, a liquid grinding aid of the invention may be beneficial. Thus, the use of a liquid grinding aid is in part dependent upon the work required, which is a function of the T_{g} (softness/hardness) of the polymer.

In one non-limiting embodiment herein, the size reduction for producing particulate polymer drag reducing agent is conducted at non-cryogenic temperatures. For the purposes of this invention, cryogenic temperature is defined as the glass transition temperature (T_{g}) of the particular polymer having its size reduced or being ground, or below that temperature. It will be appreciated that T_{g} will vary with the specific polymer being ground. Typically, T_{g} ranges between about −10° C. and about −100° C. (about 14° F. and about −148° F.), in one non-limiting embodiment. In another non-limiting embodiment, the size reduction or grinding for producing particulate polymer drag reducing agent is conducted at ambient temperature. For the purposes of this invention, ambient temperature conditions are defined as between about 20-25° C. (about 68-77° F.). In another non-restrictive version, ambient temperature is defined as the temperature at which grinding or size reduction occurs without any added cooling. Because heat is generated in the grinding or size reduction process, “ambient temperature” may thus in some contexts mean a temperature greater than about 20-25° C. (about 68-77° F.). In still another non-limiting embodiment, the size reduction or grinding to produce particulate polymer drag reducing agent is conducted at a chilled temperature that is less than ambient temperature, but that is greater than cryogenic temperature for the specific polymer having its size reduced. A preferred chilled temperature may range from about −7 to about 2° C. (about 20 to about 35° F.). Nevertheless, in some embodiments of the invention, the size reduction of the DRA polymer may be conducted at or below T_{g} for that particular polymer.

If the liquid grinding aid is added in small quantities (small doses are generally the most effective), then the action of the liquid is not to aid in the shearing mechanism, but rather to aid in the lubricity of the recirculating, pulverizing system such that hot spots due to mechanical shear are greatly reduced or eliminated. If mechanical shearing forces are too great (a temperature rise with higher shear) and the polymer experiences instantaneous points of high heat, then gel balls form quite readily (soft polymer agglomerates). Also, without the addition of the liquid grinding aid in small quantities, rubbery polymer may tend to build up on pulverizing blade surfaces. Again, lubricity of the system plays a key role in maintaining an efficient size reduction operation; an efficient system as defined by a smooth flowing recirculating/pulverizing operation with little polymer build-up on metal surfaces, lack of gel ball formation, and in conjunction with suitable production rates. Suitable production rates include, but are not necessarily limited to, a minimum of 100 to an upper rate of about 300 lbs. per hour or more (45-136 kg/hr).

On the other hand, if too much of the liquid grinding aid is injected into the pulverizing operation, production rates may be slowed due to the build up of surface tension (high surface tension imparted by the liquid grinding aid) on the shaker screens by which ground polymer exits. If such conditions exist, then one may add solid grinding aid to dry or absorb some of the liquid, reduce surface tension, and increase throughput. In various non-limiting embodiments of the invention, the liquid grinding aid is sprayed, atomized or otherwise injected onto the granulated polymer in relatively small quantities.

Generally, the polymer that is processed in the methods herein may be any conventional or well known polymeric drag reducing agent (DRA) including, but not necessarily limited to, poly(alpha-olefin), polychloroprene, vinyl acetate polymers and copolymers, poly(alkylene oxide), and mixtures thereof and the like. For the methods herein to be successful, the polymeric DRA would have to be of sufficient structure (molecular weight) to exist as a neat solid which would lend itself to the pulverizing or size reduction process, i.e. that of being sheared or ground by mechanical forces to smaller particles. A DRA of a harder, solid nature (relatively higher glass transition temperature) than poly(alpha-olefin) would certainly work. A DRA of a relatively softer nature (lower glass transition temperature, more rubbery polymer) would be more difficult to pulverize by this process. A DRA that exists as dissolved in solution (gel polymers) would have no applicability here, of course.

Further details about non-cryogenic grinding of DRA polymers may be found in U.S. Pat. No. 6,946,500 to Harris, et al. (Baker Hughes Incorporated), incorporated by reference herein.

Utilization of the liquid grinding aid in accordance with the inventive method may allow one to pulverize softer polymers of any structure, up to a point. However, some polymers would be too soft, and the softening temperatures of the polymers would be reached quickly under shear, and agglomeration could not be prevented. Also, due to the differing chemical structures and surface energy wetting properties, one may not be able to find an appropriate liquid grinding aid that would lend lubricity to the pulverizing operation. For example, rubbery polysiloxanes could not be wetted to any significant extent or degree with glycolic mixtures and thus would tend to agglomerate with increased heat buildup rather than wet and slip past one another.

Poly(alpha-olefin) is a preferred polymer in one non-limiting embodiment of the invention. Poly(alpha-olefins) (PAOs) are useful to reduce drag and friction losses in flowing hydrocarbon pipelines and conduits. Prior to the process of this invention, the polymer may have already been granulated, that is, broken up or otherwise fragmented into granules in the range of about 6 mm to about 20 mm, in another non-limiting embodiment from about 8 mm to about 12 mm. It is permissible for the granulated polymer to have an anti-agglomeration agent thereon. Such anti-agglomeration agents include, but are not necessarily limited to talc, alumina, ethylene bis-stearamide, and the like and mixtures thereof

Within the context of the methods herein, the term “granulate” refers to any size reduction process that produces a product that is relatively larger than that produced by grinding or finer size reduction, including, but not necessarily limited to, chopping and cutting. Further within the context of the methods herein, “high shear processing”, “homogenizing” and “grinding” refer to size reduction processes that gives a product relatively smaller than that produced by “granulation”. “Size reduction” may refer to any milling, pulverization, attrition, grinding or other size diminution that results in particulate polymer drag reducing agents of the size and type that are the goal of the compositions and methods herein.

While grinding mills, particularly attrition mills such as Pallmann attrition mills, Munson centrifugal impact mills, Palmer mechanical reclamation mills, etc. may be used in various non-limiting embodiments of the invention, other grinding machines may be used in the methods herein as long as the stated goals are achieved, in non-limiting instances, homogenizers and high shear material processors.

The solid organic grinding aid may be any finely divided particulate or powder that inhibits, discourages or prevents particle agglomeration and/or gel ball formation during grinding. The solid organic grinding aid may also function to provide the shearing action necessary in the pulverizing or grinding step to achieve polymer particles of the desired size. The solid organic grinding aid itself has a particle size, which in one non-limiting embodiment ranges from about 1 to about 50 microns, preferably from about 10 to about 50 microns. Suitable solid organic grinding aids include, but are not necessarily limited to, ethene/butene copolymer (such as Microthene, available from Equistar, Houston), paraffin waxes (such as those produced by Baker Petrolite Corporation), solid, high molecular weight alcohols (such as Unilin alcohols available from Baker Petrolite Corporation), and any non-metallic, solid compounds composed of C and H, and optionally N and/or S which can be prepared in particle sizes of 10-50 microns suitable for this process, and mixtures thereof. Talc and ethylene bis-stearamide were discovered to be ineffective as solid, organic grinding aids. In one non-restrictive, alternative embodiment, the solid organic grinding aid has an absence of fatty acid waxes.

The liquid grinding aid may provide lubricity to the system during grinding. Suitable liquid grinding aids include any which impart lubricity to the surface of the polymer being ground. Specific examples include, but are not necessarily limited to, a blend of a glycol with water and/or an alcohol. Suitable glycols include, but are not necessarily limited to, ethylene glycol, propylene glycol, diethylene glycol, dipropylene glycol, methyl ethers of such glycols, and the like, and mixtures thereof. Suitable alcoholic liquids include, but are not necessarily limited to, methanol, ethanol, isopropanol (isopropyl alcohol, IPA), and the like and mixtures thereof. Liquid grinding aids that are non-harmful to the environment are particularly preferred. In one non-restrictive embodiment, the liquid grinding aid is the blend of glycol, water and IPA. The proportions of the three components in this blend may range from about 20 to 80 wt. % to about 20 to 80 wt. % to about 0 to 30 wt. %, respectively, preferably from about 20 to 80 wt. % to about 20 to 80 wt. % to about 0 to 20 wt. %, respectively. In one non-limiting embodiment of the invention, the liquid grinding aid is atomized or sprayed into the grinding or pulverizing chamber and/or onto the polymer granules as they are fed to the chamber.

It will be appreciated that there will be a number of different specific ways in which the methods and compositions may be practiced that are within the scope of the invention, but that are not specifically described herein. For instance, in one non-limiting embodiment, the granulated polymer is fed into the grinding chamber at a rate of from about 100 to about 300 lbs/hr (45-136 kg/hr), the solid organic grinding aid is fed at a rate of from about 10 to about 90 lb/hr (4.5-41 kg/hr), and the liquid grinding aid is fed at a rate of from about 0.01 to about 0.5 gallons per minute (0.04-1.9 liters per minute). Preferably, the granulated polymer is fed into the grinding chamber at a rate of from about 200 to about 300 lb/hr (91-136 kg/hr), the solid organic grinding aid is fed at a rate of from about 10 to about 30 lb/hr (4.5-14 kg/hr), and the liquid grinding aid is fed at a rate of from about 0.01 to about 0.1 gallons per minute (0.04-0.4 liters per minute). As noted, all of the components may be fed simultaneously to the grinding chamber. Alternatively, the components may be mixed together prior to being fed to the grinding chamber. In another non-limiting embodiment, the components are added sequentially, in no particular order or sequence. Stated another way, the ratio of solid organic grinding aid to liquid grinding aid (on a weight/weight basis) may range from about 0.15 to about 0.45 pound per pound of polymer (kg/kg), preferably from about 0.2 to about 0.3 pound per pound of polymer (kg/kg). Grinding speeds of up to 3600 rpm were utilized in a Pallmann PKM-600 model for a single rotating disk, and 3600, 5000 rpm, respectively, utilized in a Universal mill fitted with counter-rotating disks, were found to be acceptable in specific, non-limiting embodiments of the invention.

In another non-limiting embodiment, it is expected that the processes described herein will produce particulate polymer drag reducing agent product where the average particle size is less than about 600 microns, preferably where at least 90 wt % of the particles have a size of less than about 600 microns or less, alternatively 100 wt % of the particles have a size of 500 microns or less, and most preferably about 61 wt % of the particles have a size of 297 microns or less in non-limiting embodiments. One achievable distribution is shown in Table I utilizing a PKM-600 model grinder; a series of other particle distributions vs. the screen size is displayed in Table II with the Universal Mill. The variable screen sizes were changed out within the collection device during numerous grinds in the Universal Mill.

TABLE I

| Micron Retained | Screen Mesh Size | Percent |
|---|---|---|
| 500 | 35 | 38.8 |
| 297 | 50 | 55.7 |
| 210 | 70 | 4.1 |
| 178 | 80 | 0.4 |
| 150 | 100 | 0.4 |
| pan | pan | 0.6 |

TABLE II

| Particle Size | | | |
|---|---|---|---|
| (microns) | 35 Mesh Screen | 30 Mesh Screen | 20 Mesh Screen |
| 800 | 5 | 2 | 2 |
| 700 | | | |
| 600 | | | 17 |
| 500 | 4 | 11 | 18 |
| 400 | 35 | 27 | 20 |
| 200 | 35 | 32 | 24 |
| 100 | 14/7 | 16/12 | 11/8 |

It is expected that the resulting particulate polymer DRAs can be easily transported without the need of including an inert solvent or any additional inert solvents other than those described, and that the particulate polymer DRAs can be readily inserted into and incorporated within a flowing hydrocarbon, aqueous fluid, oil-in-water emulsion or water-in-oil emulsion, as appropriate. DRA products made by the processes herein are free-flowing and contain a high percentage, from about 70-80% of active polymer. Furthermore, there is an absence of any need to add an anti-agglomeration aid to the DRA after it is ground to its desirable size. If the balance of liquid grinding aid and solid grinding aid is properly optimized, any excess liquid grinding aid is absorbed by the solid grinding aid.

Nevertheless, in one non-restrictive embodiment, the particulate polymer DRAs from the above-described non-cryogenic grinding process may be combined with a non-solvent to form a ground polymer slurry. Suitable liquid, non-solvents for PAOs include those described in U.S. Pat. No. 5,733,953, previously incorporated by reference, including, but not necessarily limited to, isopropyl alcohol (IPA), other alcohols, glycols, glycol ethers, ketones, esters, all of which contain from 2 to 6 carbon atoms. The weight ratio of non-solvent to solvent after the addition of the non-solvent may range from about 70/30 to about 30/70, preferably from about 60/40 to about 40/60, and in one embodiment is especially preferred to be about 50/50. In other words, in one embodiment, at least 40 wt. % of the solvent is replaced with the liquid, non-solvent. In the case of PAOs, suitable solvents may include, but are not necessarily limited to kerosene, jet fuel, paraffinic and isoparaffinic solvents. The polyalphaolefins are polymerized from the monomers or comonomers by conventional techniques and will have molecular weights above 10 million per analysis by gel permeation chromatography (GPC).

In another non-limiting embodiment of the invention, the bulk polymer, in granulated or other form, is ground or otherwise size-reduced, either at cryogenic temperatures or non-cryogenic temperatures, directly into the precipitation polymer slurry as a “quenching system” to receive the ground polymer to inhibit or prevent agglomeration of the ground bulk polymer. In this embodiment, the blending of the two slurry types occurs simultaneously with the forming of the ground polymer slurry.

### EXAMPLE 1

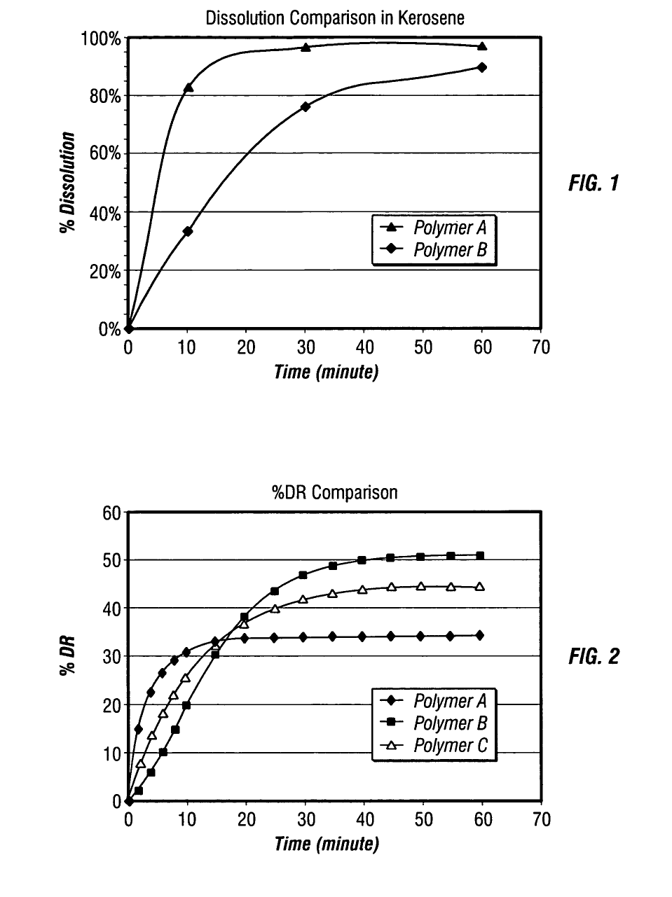

Examples of two compositionally similar DRA polymers, yet having differing production techniques, were selected for laboratory evaluations. Polymer A was a solution polymerized DRA polymer further precipitated via incorporation of blocking agent in non-solvent to yield a polymer/non-solvent mixture. Polymerization solvent was stripped from the mixture upon completion of the precipitation process to yield a stable polymer slurry. This polymer/blocking agent/non-solvent slurry was further concentrated to yield a 40% by weight polymer mixture via bag or sock filtration methods. Polymer B was produced by bulk or neat polymerization methods utilizing a Plate and Frame heat transfer apparatus to yield a solid slab of polymer. The slab polymer was granulated with granulation aid to a size of ¼ inch (0.6 cm) and ground further to a finer size in a Ross Megashear homogenizer utilizing a non-solvent and slurry aid. The stable slurry of Polymer B contained a known quantity of polymer and granulation aid or blocking agent. Polymer A and Polymer B were subsequently blended together to make a stable dispersion or Mixture C which contained 3 parts Polymer A and 2 parts Polymer B, a known quantity of blocking agent, as well as non-solvent dispersive fluid. Polymer A and Polymer B were tested independently for dissolution behavior in kerosene hydrocarbon solvent at equivalent polymer concentrations and that data is shown in Table III. A plot of the dissolution behavior is shown as FIG. 1.

TABLE III
Dissolution of Two Polymers in Kerosene

Percentage Dissolution
Dissolution Time (minute)

| | 0 | 10 | 30 | 60 |
|---|---|---|---|---|
| Polymer A | 0% | 82.7% | 96.6% | 97.1% |
| Polymer B | 0% | 33.7% | 76.0% | 89.7% |

From these data it can be seen that Polymer A is a solution polymerized/precipitated polymer slurry that dissolves quite rapidly in hydrocarbon media and reaches near maximum dissolution or drag reduction in the early stages of dissolution. Polymer B on the other hand lags behind significantly in dissolution or drag reduction performance as it dissolves slowly in the kerosene. Thus Polymer A dissolves quickly in hydrocarbon fluids and begins to shear degrade over some time as turbulent flow continues. Polymer B, being a slurry product produced via bulk polymerization with further grinding methodology, is shown to dissolve at a significantly lower rate than that of Polymer A, but can be extrapolated to reach maximum dissolution and drag reduction at some later time in the act of dissolution. Eventual shear degradation of Polymer B would occur after complete dissolution and at some longer time in the turbulent hydrocarbon fluid.

Thus, to accommodate drag reduction along the length of a pipeline, it is possible to blend DRA slurries having differing rates of dissolution. Quickly dissolving polymer slurry such as Polymer A would accommodate the very initial time-frames of injection into and drag reduction of a hydrocarbon fluid, whereas, slower dissolving polymer slurry (Polymer B) would dissolve slower and maintain effective drag reduction in the longer times or lengths of a hydrocarbon fluid pipeline.

Due to the fact that a standard calibration curve must be produced independently for each polymer tested, a dissolution curve cannot be generated for the dissolution of the Mixture C above (combination of Polymer A and Polymer B). However, one can place Mixture C in kerosene and directly observe the actual drag reduction in that fluid over time. The drag reduction results would be a combinational effect of both Polymer A and Polymer B as they dissolve. Experimental data gathered during such an experiment is plotted in FIG. 2.

In FIG. 2 drag reduction versus time has been measured for 3 solutions having the same concentration of polymer in each. Thus, both test solutions of Polymer A and Polymer B were produced with 0.25 ppm of polymer in solution. Mixture C is the combination of Polymer A and Polymer B, yet the total polymer concentration for the measurement above is again 0.25 ppm polymer. In having the 3 to 2 ratio of Polymer A to Polymer B comprising Mixture C, the effect of the blend on drag reduction is quite clear. In the early stages of dissolution, Polymer A imparts its effect of rapid dissolution and improved drag reduction upon the overall field of flow. Polymer B, on the other hand, makes its effect felt in the later stages of dissolution. Due to the slower rate of dissolution, Polymer B lends itself to a higher and sustained drag reduction in the Mixture C over that of Polymer A by itself. In summary, the combination of Polymer A and Polymer B and their effective but distinct performances produces a much more efficient drag reducer in combination in the drag reduction of hydrocarbon fluids.

A process has thus been described and demonstrated for producing a particulate polymer drag reducing agent that is effective over a relatively extended period of time. The particulate polymer DRA may be readily manufactured and does not necessarily require cryogenic temperatures to be produced. The particulate polymer DRA blend herein does not cold flow upon standing once it is made.

Many modifications may be made in the composition and process of this invention without departing from the spirit and scope thereof that are defined only in the appended claims. For example, the exact nature of and proportions of precipitation polymer slurry, ground polymer slurry, polymers used in the slurries, etc., may be different from those used here. Particular processing techniques may be developed to enable the components to be homogeneously blended and work together well, yet still be within the scope of the invention. Additionally, feed rates of the various components are expected to be optimized for each type of size reduction and blending equipment and for each combination of components employed.

What is claimed is:

1. A drag reducing composition for reducing drag in a hydrocarbon fluid in a controlled manner over a period of time comprising:
a precipitation polymer slurry formed by polymer precipitation, where the polymer of the precipitation polymer slurry dissolves relatively quickly in the hydrocarbon fluid; and
a size-reduced polymer formed by reducing the size of bulk polymer, where the method for size reduction is selected from the group consisting of cryogenic size reduction and size reduction in the absence of cryogenic temperatures, where size-reduced polymer dissolves relatively slowly in the hydrocarbon fluid.

2. The drag reducing composition of claim 1 where the size-reduced polymer is produced by grinding the bulk polymer into the precipitation polymer slurry.

3. The drag reducing composition of claim 1 where the polymer of the precipitation polymer slurry and the size-reduced polymer are poly(alpha-olefin).

4. The drag reducing composition of claim 1 where the size-reduced polymer is combined with a liquid media to form a size-reduced polymer slurry which in turn is combined with the precipitation polymer slurry.

5. The drag reducing composition of claim 4 where the size-reduced polymer slurry is produced by a method comprising
feeding to a mill components comprising:
granulated polymer; and
at least one solid organic grinding aid; and
grinding the components to produce particulate polymer drag reducing agent; and
combining a liquid media with the particulate polymer drag reducing agent to form a size-reduced polymer slurry.

6. The drag reducing composition of claim 5 where the solid organic grinding aid is selected from the group consisting of ethene/butene copolymer, paraffin waxes, solid alcohols, and mixtures thereof.

7. The drag reducing composition of claim 6 further comprising feeding a liquid grinding aid to the mill.

8. The drag reducing composition of claim 7 where the liquid grinding aid is a blend of at least one glycol selected from the group consisting of ethylene glycol, propylene glycol, diethylene glycol, dipropylene glycol, methyl ethers of such glycols, and mixtures thereof, and at least one other liquid selected from the group consisting of water and an alcohol, the alcohol being selected from the group consisting of methanol, ethanol, isopropanol and mixtures thereof.

9. The drag reducing composition of claim 1 where the precipitation polymer and the size-reduced polymer, each individually comprises polymer particulates with an average particle size of equal to or less than about 600 microns.

10. The drag reducing composition of claim 1 where the precipitation polymer slurry is formed by a method comprising:
polymerizing at least one monomer in a solvent to form a polymer in the solvent;
adding a liquid non-solvent to the polymer in the solvent to produce a mixture of polymer, solvent and non-solvent, at a rate to precipitate the polymer into polymer particles of average diameter equal to or less than 0.10 inches (0.25 cm) and to reduce the viscosity of the mixture;
separating a slurry concentrate of precipitated polymer particles from a supernatant layer of solvent and liquid, non-solvent; and
reducing the residual solvent in the slurry concentrate of precipitated polymer particles by a process selected from the group of processes consisting of:
extracting at least a portion of the residual solvent by additional liquid non-solvent, and
evaporating at least a portion of any residual solvent to produce a slurry concentrate containing polymer particles in liquid non-solvent to produce the precipitation polymer slurry directly usable as a drag reducing agent without grinding.

11. The drag reducing composition of claim 10 where the weight ratio of non-solvent to solvent after the addition of the non-solvent is about 70/30 to about 30/70.

12. The drag reducing composition of claim 1 where the ratio of precipitation polymer to size-reduced polymer ranges from about 4:1 to about 1:4.

13. A drag reducing composition for reducing drag in a hydrocarbon fluid in a controlled manner over a period of time comprising:
a precipitation polymer slurry formed by polymer precipitation, where the polymer of the precipitation polymer slurry dissolves relatively quickly in the hydrocarbon fluid; and
a size-reduced polymer slurry formed by grinding bulk polymer into the precipitation polymer slurry, where the grinding is conducted in the absence of cryogenic temperatures, where polymer of the size-reduced polymer slurry dissolves relatively slowly in the hydrocarbon fluid,
where the polymer in the precipitation polymer slurry and in the size-reduced polymer slurry are poly(alpha-olefin).

14. The drag reducing composition of claim 13 where the precipitation polymer and the size-reduced polymer, each individually comprises polymer particulates with an average particle size of equal to or less than about 600 microns.

15. A method for making a drag reducing composition for reducing drag in a hydrocarbon fluid in a controlled manner over a period of time, the method comprising:
forming a precipitation polymer slurry by precipitating a polymer, where the polymer of the precipitation polymer slurry dissolves relatively quickly in the hydrocarbon fluid;
forming a size-reduced polymer by grinding, where the size reduction is selected from the group consisting of cryogenic size reduction and size reduction in the absence of cryogenic grinding, where the size-reduced polymer dissolves relatively slowly in the hydrocarbon fluid; and
combining the precipitation polymer slurry and the size-reduced polymer.

16. The method of claim 15 further comprising grinding the bulk polymer into the precipitation polymer slurry.

17. The method of claim 15 further comprising combining the size-reduced polymer with a liquid media to form a size-reduced polymer slurry and in turn combining the size-reduced polymer slurry with the precipitation polymer slurry.

18. The method of claim 15 where forming the size-reduced polymer slurry comprises
feeding to a mill components comprising:
granulated polymer; and
at least one solid organic grinding aid; and
grinding the components to produce particulate polymer drag reducing agent; and
adding a liquid non-solvent to the particulate polymer drag reducing agent to form a size reduced polymer slurry.

19. The method of claim 18 where the solid organic grinding aid has a size between about 1 and about 50 microns.

20. The method of claim 18 where the solid organic grinding aid is selected from the group consisting of ethene/butene copolymer, paraffin waxes, solid alcohols, and mixtures thereof.

21. The method of claim 18 further comprising feeding a liquid grinding aid to the mill.

22. The method of claim 21 where the liquid grinding aid is a blend of at least one glycol selected from the group consisting of ethylene glycol, propylene glycol, diethylene glycol, dipropylene glycol, methyl ethers of such glycols, and mixtures thereof, and at least one other liquid selected from the group consisting of water and at least one alcohol, the alcohol being selected from the group consisting of methanol, ethanol, isopropanol and mixtures thereof.

23. The method of claim 16 where the precipitation polymer and the size-reduced polymer, each individually comprises polymer particulates with an average particle size of equal to or less than about 600 microns.

24. The method of claim 16 where the polymer in the precipitation polymer slurry and in the size-reduced polymer are poly(alpha-olefin).

25. The method of claim 15 where in forming the precipitation polymer slurry, the forming comprises:
polymerizing at least one monomer in a solvent to form a polymer in the solvent;
adding a liquid non-solvent to the polymer in the solvent to produce a mixture of polymer, solvent and non-solvent, at a rate to precipitate the polymer into polymer particles of average diameter equal to or less than 0.10 inches (0.25 cm) and to reduce the viscosity of the mixture;
separating a slurry concentrate of precipitated polymer particles from a supernatant layer of solvent and liquid, non-solvent; and
reducing the residual solvent in the slurry concentrate of precipitated polymer particles by a process selected from the group of processes consisting of:
extracting of at least a portion of the residual solvent by additional liquid non-solvent, and
evaporating at least a portion of the residual solvent to produce a slurry concentrate containing polymer particles in liquid, non-solvent to produce the precipitation polymer slurry directly usable as a drag reducing agent without grinding.

26. The method of claim 25 where in adding a liquid, non-solvent to the polymer, the weight ratio of non-solvent to solvent after the addition of the non-solvent is about 70/30 to about 30/70.

27. The method of claim 15 where the ratio of precipitation polymer to size-reduced polymer ranges from about 4:1 to about 1:4.

28. A method for making drag reducing composition for reducing drag in a hydrocarbon fluid in a controlled manner over a period of time, the method comprising:
forming a precipitation polymer slurry by precipitating a polymer, where the polymer of the precipitation polymer slurry dissolves relatively quickly in the hydrocarbon fluid;
forming a size-reduced polymer slurry by grinding bulk polymer into the precipitation polymer slurry, where the grinding is conducted in the absence of cryogenic temperatures, where polymer of the size-reduced polymer slurry dissolves relatively slowly in the hydrocarbon fluid,
where the polymer in the precipitation polymer slurry and in the size-reduced polymer slurry are poly(alpha-olefin).

29. The method reducing composition of claim 28 where the precipitation polymer slurry and the size-reduced polymer slurry, each slurry individually comprises polymer particulates with an average particle size of equal to or less than about 600 microns.

30. A hydrocarbon stream having reduced drag comprising:
a hydrocarbon; and
an amount of a drag reducing composition effective to reduce drag of the hydrocarbon, where the drag reducing composition comprises:
a precipitation polymer slurry formed by polymer precipitation, where the polymer of the precipitation polymer slurry dissolves relatively quickly in the hydrocarbon fluid; and
a size-reduced polymer formed by reducing the size of bulk polymer, where the method for size reduction is selected from the group consisting of cryogenic size reduction and size reduction in the absence of cryogenic temperatures, where the size-reduced polymer dissolves relatively slowly in the hydrocarbon fluid.

31. The hydrocarbon stream of claim 30 where the size-reduced polymer slurry is produced by grinding the bulk polymer into the precipitation polymer slurry.

32. The hydrocarbon stream of claim 30 where the polymer in the precipitation polymer slurry and in the size-reduced polymer are poly(alpha-olefin).

33. The hydrocarbon stream of claim 30 where the precipitation polymer and the size-reduced polymer, each individually comprises polymer particulates with an average particle size of equal to or less than about 600 microns.

34. The hydrocarbon stream of claim 30 where the ratio of precipitation polymer to size-reduced polymer ranges from about 4:1 to about 1:4.
